(19) United States
(12) Patent Application Publication
(10) Pub. No.: US 2022/0333562 A1
(43) Pub. Date: Oct. 20, 2022

(54) VARIABLE ENGINE-INLET BYPASS CONTROL SYSTEMS AND METHOD

(71) Applicant: Bell Textron Inc., Fort Worth, TX (US)

(72) Inventors: Thomas PARSONS, Fort Worth, TX (US); Charles Eric COVINGTON, Colleyville, TX (US)

(73) Assignee: Bell Textron Inc., Fort Worth, TX (US)

(21) Appl. No.: 17/235,239

(22) Filed: Apr. 20, 2021

(51) Int. Cl. F02M 35/10; F02C 3/00

(52) U.S. Cl. CPC F02M 35/1038; F02C 3/00; F05D 2220/323

(57) ABSTRACT

A system for optimizing engine air-mass-flow intake of an aircraft includes a forward-facing airframe-inlet duct interoperably coupled to an inlet of an engine of the aircraft, an air-mass-flow bypass mechanism coupled to the forward-facing airframe-inlet duct and adjustable to allow a selected amount of air entering an inlet of the forward-facing airframe-inlet duct to bypass the inlet of the engine, and an air-pressure sensor arranged in the forward-facing airframe-inlet duct adjacent to the inlet of the engine. A measured value (“PT1”) from the air-pressure sensor is used to determine a degree to which the air-mass-flow bypass mechanism is to be opened.

### CROSS-REFERENCE TO RELATED APPLICATIONS

This patent application incorporates by reference the entire disclosure of a US patent application filed on the same date as this patent application and bearing attorney docket no. RR60388.P142US1.

### TECHNICAL FIELD

The present disclosure relates generally to methods for varying aircraft engine-inlet bypass geometry and more particularly, but not by way of limitation, to varying aircraft engine-inlet bypass geometry in response to engine and environmental conditions in order to minimize spillage drag.

### BACKGROUND

This section provides background information to facilitate a better understanding of the various aspects of the disclosure. It should be understood that the statements in this section of this document are to be read in this light and not as admissions of prior art.

Spillage drag occurs when a forward-facing airframe inlet duct intakes more airflow than the engine's compressor can ingest under particular conditions. As a result, air “spills” around the outside of the inlet duct rather than being conducted to the engine. The amount of air that is ingested by the compressor is dependent on, among other things, airspeed, altitude, and engine throttle setting.

The inlet duct is usually sized to pass a maximal airflow that the engine can ingest (i.e., maximal engine air demand); as such, for all other conditions, the inlet duct will spill a difference between the airflow and the maximal engine air demand. Spilled air results in undesirable conditions, including drag; such draft is commonly referred to as spillage drag.

### SUMMARY

This summary is provided to introduce a selection of concepts that are further described below in the detailed description. This summary is not necessarily intended to identify key or essential features of the claimed subject matter, nor is it intended to be used as an aid in limiting the scope of claimed subject matter.

A system for optimizing engine air-mass-flow intake of an aircraft includes a forward-facing airframe-inlet duct interoperably coupled to an inlet of an engine of the aircraft, an air-mass-flow bypass mechanism coupled to the forward-facing airframe-inlet duct and adjustable to allow a selected amount of air entering an inlet of the forward-facing airframe-inlet duct to bypass the inlet of the engine, and an air-pressure sensor arranged in the forward-facing airframe-inlet duct adjacent to the inlet of the engine. A measured value (“PT1”) from the air-pressure sensor is used to determine a degree to which the air-mass-flow bypass mechanism is to be opened.

A system for optimizing engine air-mass-flow intake of an aircraft includes a forward-facing airframe-inlet duct interoperably coupled to an inlet of an engine of the aircraft and a spring-loaded air-mass-flow bypass mechanism coupled to the forward-facing airframe-inlet duct and operable to allow a variable amount of air entering an inlet of the forward-facing airframe-inlet duct to bypass the inlet of the engine.

A method of optimizing engine air-mass-flow intake of an aircraft includes sensing an air-pressure value within a forward-facing airframe-inlet duct and adjacent to an inlet of the engine coupled to the forward-facing airframe-inlet duct, comparing the sensed air-pressure value to a free-stream ambient air-pressure value, responsive to the comparing, determining an optimal position of an air-mass-flow bypass mechanism coupled to the forward-facing airframe-inlet duct, and responsive to the determining, positioning the air-mass-flow bypass mechanism to be in the optimal position.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1 is a schematic of a system in which spillage of air from an inlet duct is occurring;

FIG. 2 is a schematic of a system in which a bypass door is in a closed position;

FIG. 3 is a schematic of the system of FIG. 2 in which the bypass door is in a partially open position;

FIG. 4 is a schematic of the system of FIG. 2 in which the bypass door is in a fully open position;

FIG. 5 is a mass flow balance diagram based on the system of FIG. 2;

FIG. 6 is a flow diagram that illustrates a variable engine-inlet bypass control method that can be used with the system of FIGS. 2-5;

FIG. 7 is a schematic of a system that utilizes a pressure sensor and in which a bypass door is in a partially open position;

FIG. 8 is a flow diagram that illustrates a variable engine-inlet bypass control method that can be used with the system of FIG. 7;

FIG. 9A is a schematic of a system that utilizes a spring-loaded bypass door and in which the spring-loaded bypass door is in a closed position;

FIG. 9B is a schematic of the system of FIG. 9A in which the bypass door is in a partially open position; and

FIG. 10 is a schematic of a system that utilizes a spring-loaded check valve.

### DETAILED DESCRIPTION

Various embodiments will now be described more fully with reference to the accompanying drawings. The disclosure may, however, be embodied in many different forms and should not be construed as limited to the embodiments set forth herein.

In a typical embodiment, a bypass flow path of a forward-facing airframe inlet duct is provided to allow excess air to escape the forward-facing airframe inlet duct in a controlled manner such that the excess air does not reach an aircraft engine. The bypass flow path typically includes an adjustable bypass door that may be used to control the amount of air that escapes the forward-facing airframe inlet duct and employs an algorithm to determine an optimal bypass geometry as a function of one or more flight conditions. The algorithm may utilizes aircraft parameters and existing models and relationships to determine, for example, an optimal bypass door position so as to minimize spillage drag as a function, for example, of airspeed and engine power setting at current ambient conditions such as altitude and outside ambient temperature (“OAT”). Utilization thereof reduces spillage drag and improves various aircraft performance parameters such as range, fuel burn, and maximal airspeed capability.

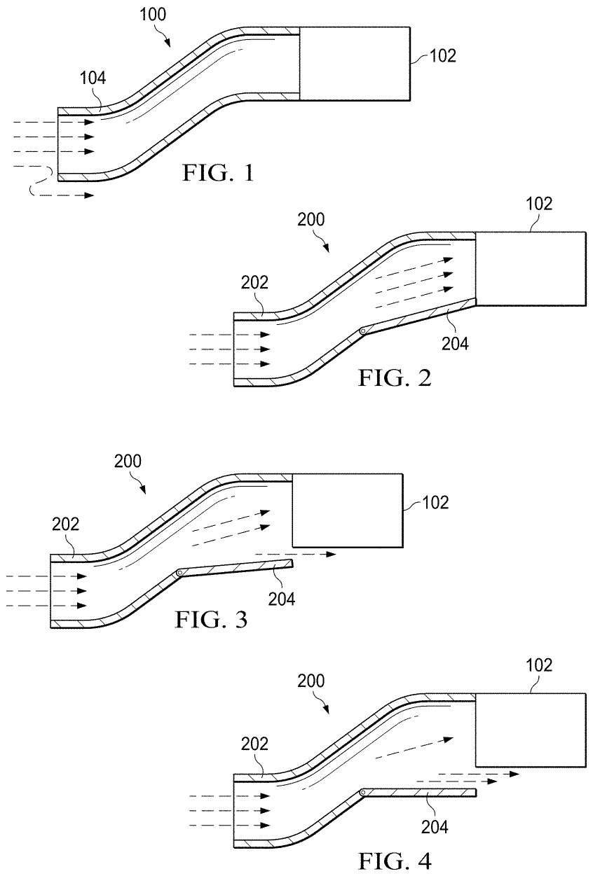

FIG. 1 is a schematic of a system in which spillage of air from an inlet duct is occurring. A system 100 includes an engine 102 and a forward-facing airframe inlet duct 104. Arrows in FIG. 1 illustrate air mass flow entering the forward-facing airframe inlet duct 104, some of which air mass flow spills outside the forward-facing airframe inlet duct 104. Air mass flow is defined as follows:

M=A×S×D

where A is area, S is airspeed, and D is air density.

FIG. 2 is a schematic of a system in which a bypass door is in a closed position. A system 200 includes the engine 102 and a forward-facing airframe inlet duct 202. In similar fashion to FIG. 1, arrows in FIG. 2 illustrate air mass flow entering the forward-facing airframe inlet duct 202. In contrast to the system 100, in the system 200, the forward-facing airframe inlet duct 202 includes a bypass door 204, the bypass door 204 being shown in a closed position. Although the bypass door 204 is shown in FIG. 2, those having skill in the art will appreciate that other mechanisms besides a door may be utilized to adjust an opening of the forward-facing airframe inlet duct 202 to change an amount of air mass flow that passes therethrough. Any and all conceivable configurations by which an opening can be adjusted to varying degrees from fully open to fully closed could be employed. For example, a door that slides open and closed could be used. The bypass door 204 may be placed in a location where any drag impact thereof could be minimized.

FIG. 3 is a schematic of the system of FIG. 2 in which the bypass door 204 is in a partially open position. In the partially open position, the bypass door 204 permits a portion of total air mass flow that enters the forward-facing airframe inlet duct 202 to escape such that the portion of the total air mass flow does not reach the engine 102.

FIG. 4 is a schematic of the system of FIG. 2 in which the bypass door 204 is in a fully open position. In the fully open position, assuming equal total air mass flow entering the forward-facing airframe inlet duct 202 to that of FIG. 3, the bypass door 204 permits a greater portion than that shown in FIG. 3 of the total air mass flow that enters the forward-facing airframe inlet duct 202 to escape such that the greater portion of the total air mass flow does not reach the engine 102.

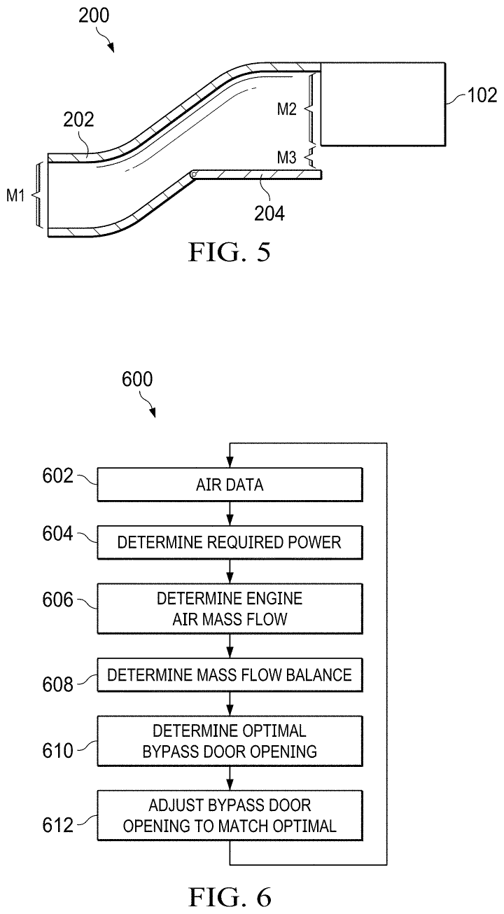

FIG. 5 is a schematic of the system of FIG. 2 in which the bypass door 204 is in a partially open position and mass flow balance is illustrated. In the partially open position, the bypass door 204 permits a portion of total air mass flow that enters the forward-facing airframe inlet duct 202 to escape such that the portion of the total air mass flow does not reach the engine 102. FIG. 5 shows that air mass flow at the forward-facing airframe inlet duct (“M1”) is equal to engine air mass flow (“M2”) plus variable engine-inlet bypass air mass flow (“M3”). In other words, M1=M2+M3. In a typical embodiment, M3 is adjusted so that M2 is equal to an air mass flow amount required by the engine (“MR”) under particular flight conditions.

FIG. 6 is a flow diagram that illustrates a variable engine-inlet bypass control method that can be used, for example, with the system of FIGS. 2-5. Those having skill in the art will appreciate that the flow can be employed in other systems as well.

In FIG. 6, a process flow 600 begins at step 602. At step 602, air data is obtained from an air data system of an aircraft. The air data can include, for example, outside ambient temperature (“OAT”), altitude, and airspeed. From step 602, execution proceeds to step 604.

At step 604, a required engine power is determined. In a typical embodiment, the engine power required is determined using all or part of the air data obtained in step 602 utilizing at least one of developmental test data and analytical data produced, for example, from engine, inlet, and aircraft simulations. From step 604, execution proceeds to step 606.

At step 606, the engine air mass flow (“MR”) for the required engine power determined at step 604 is determined. In typical embodiment, the engine air mass flow is determined from engine performance model data obtained from a manufacturer of the engine using the required engine power determined at step 604 and at least some of the air data from step 602. From step 606, execution proceeds to step 608.

At step 608, an air mass flow balance is determined. The air mass flow balance is determined by solving M1=M2+M3 for M3. Once M3 has been determined, execution proceeds to step 610.

At step 610, an optimal bypass door opening is determined using M3 as determined at step 608. In a typical embodiment, the optimal bypass door opening (“A3”) is determined by the following equation:

A3=M3/(S3×D3)

From step 610, execution proceeds to step 612.

At step 612, an amount of opening of the bypass door is adjusted to match the optimal bypass door opening A3. Those having skill in the art will appreciate that, after the execution of step 612, M2 at least substantially matches MR. In some embodiments, M3 can be routed to a compartment at a greater temperature than M3 so as to perform a cooling function. In addition, M3 may be directed to a location of the aircraft where a drag impact thereof is minimized. From step 612, execution returns to step 602.

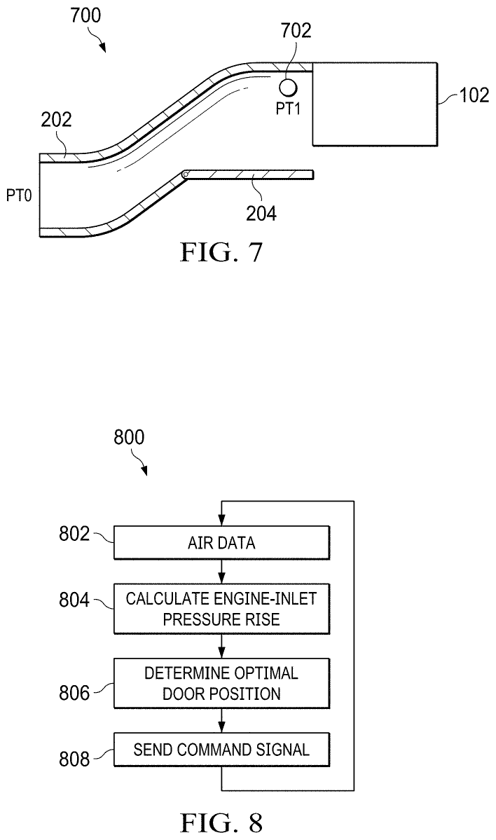

FIG. 7 is a schematic of a system that utilizes a pressure sensor and in which a bypass door is in a partially open position. A system 700 includes the engine 102, the forward-facing airframe-inlet duct 202, and the bypass door 204. Inside the forward-facing airframe-inlet duct 202 is an air-pressure sensor 702 that is positioned adjacent to an inlet of the engine 102. An air-pressure value measured by the air-pressure sensor 702 is termed total pressure and is indicated by the reference PT1. Those having skill in the art will appreciate that, in contrast to PT1, a free-stream ambient air-pressure value is typically denoted as PT0. In a typical embodiment, PT0 is calculated from OAT, altitude, and airspeed. The air-pressure sensor 702 senses PT1, which value is used to adjust how much the bypass door 204 is opened so as to minimize spillage drag.

FIG. 8 is a flow diagram that illustrates a variable engine-inlet bypass control method that can be used with the system of FIG. 7. In FIG. 8, a flow 800 begins at step 802, at which step data from an air data system is obtained. Data from the air data system includes, for example, outside ambient temperature (“OAT”), altitude, and airspeed. From step 802, execution proceeds to step 804. At step 804, an engine-inlet pressure rise is calculated. An example of how the engine-inlet pressure rise may be calculated is to calculate a ratio of PT1 to PT0. Based upon the calculated ratio, the bypass door 204 may be opened more or less in order to minimize spillage drag.

From step 804, execution proceeds to step 806, at which step a desired door position of the bypass door 204 is determined. From step 806, execution proceeds to step 808, at which step a command signal is sent to adjust a position of the bypass door 204 in order to achieve an improvement in spillage drag.

Those having skill in the art will recognize that the calculations described above relative to step 804 are not the only way that a sensed pressure by the air-pressure sensor 702 can be utilized to calculate a discrepancy between a measured value of PT1 and a desired value of PT1 that results in an improvement in spillage drag of the system 700. Such calculations will therefore not be discussed in further detail herein.

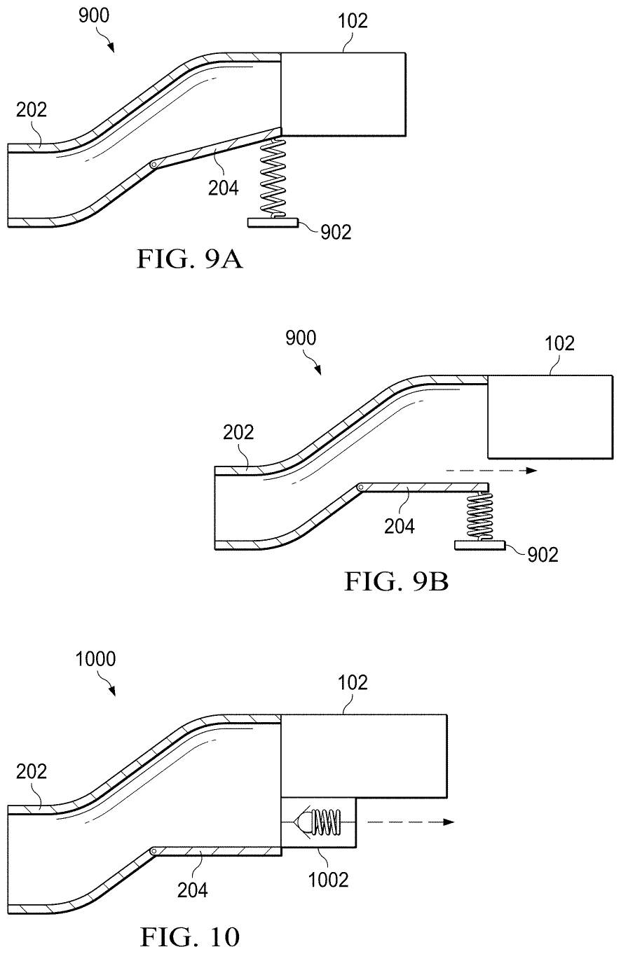

FIG. 9A is a schematic of a system that utilizes a spring-loaded bypass door and in which the spring-loaded bypass door is in a closed position. In FIG. 9A, the system 900 includes the engine 102, the forward-facing airframe-inlet duct 202, the bypass door 204, and a tuned spring 902 inter-operably coupled to the bypass door 204. The tuned spring 902 is shown in a position relative to the bypass door 204 such that the bypass door 204 is closed.

FIG. 9B is a schematic of the system 900 in which the bypass door 204 is in a partially open position. In FIG. 9B, the system 900 is shown with the tuned spring 902 in a compressed position relative to the position of the tuned spring 902 as shown in FIG. 9A. With the bypass door 204 and the tuned spring 902 as shown in FIG. 9B, airflow exiting outside of an inlet of the engine 102 is indicated by an arrow.

The tuned spring 902 is designed in order to optimize airflow into the inlet of the engine 102 and minimize spillage drag. When air flow into the inlet of the engine 102 exceeds a predetermined amount, pressure on the bypass door 204 causes the tuned spring 902 to compress such that the bypass door opens and air bypasses the inlet of the engine 102. Increased pressure on the bypass door 204 causes additional compression of the tuned spring 902 and opening of the bypass door 204 until the bypass door 204 has opened a maximal amount in accordance with design considerations.

FIG. 10 is a schematic of a system that utilize a spring-loaded check valve. In FIG. 10, a system 1000 includes the engine 102, the forward-facing airframe-inlet duct 202, the bypass door 204, and a spring-loaded check valve 1002. The spring-loaded check valve 1002 is inter-operably coupled to the bypass door 204; however, unlike other systems illustrated herein, the bypass door 204 does not open but instead remains closed. The system 1000 is illustrated as including the bypass door 204 in a fixed closed position since common parts may be used in different systems in order to avoid part proliferation. However, those having skill in the art will understand that a similar system could instead include a forward-facing airframe-inlet duct and no bypass door.

In the system 1000, the spring-loaded check valve 1002 is designed so as to open in response to air pressure that exceeds a predetermined value such that air is bled off and spillage drag is reduced. In similar fashion to the discussion above relative to the system 900, the spring-loaded check valve 1002 responds to increased air pressure by increasing loading of a spring contained therein such that more air is allowed to pass through the spring-loaded check valve until a maximal opening of the spring-loaded check valve has occurred.

The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” “generally,” and “about” may be substituted with “within 10% of” what is specified.

For purposes of this patent application, the term computer-readable storage medium encompasses one or more tangible computer-readable storage media possessing structures. As an example and not by way of limitation, a computer-readable storage medium may include a semiconductor-based or other integrated circuit (IC) (such as, for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash memory card, a flash memory drive, or any other suitable tangible computer-readable storage medium or a combination of two or more of these, where appropriate.

Particular embodiments may include one or more computer-readable storage media implementing any suitable storage. In particular embodiments, a computer-readable storage medium implements RAM or ROM. In particular embodiments, a computer-readable storage medium implements volatile or persistent memory. In particular embodiments, one or more computer-readable storage media embody encoded software.

In this patent application, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more application programming interfaces (APIs) stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, Python, Java, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

1. A system comprising:
a forward-facing airframe-inlet duct interoperably coupled to an inlet of an engine of an aircraft;
an air-mass-flow bypass door coupled to the forward-facing airframe-inlet duct and adjustable to allow a selected amount of air entering an inlet of the forward-facing airframe-inlet duct to bypass the inlet of the engine;
an air-pressure sensor arranged in the forward-facing airframe-inlet duct adjacent to the inlet of the engine;
wherein a measured value (“PT1”) from the air-pressure sensor is used to determine a degree to which the air-mass-flow bypass door is to be opened so as to optimize air-mass-flow intake to the engine and minimize spillage drag; and
wherein the determination comprises comparing PT1 to a free-stream ambient air-pressure value (“PT0”).

2. (canceled)

3. The system of claim 1, wherein an increase in PT1 causes an amount of opening of the air-mass-flow bypass door to increase.

4. The system of claim 1, wherein a decrease in PT1 causes an amount of opening of the air-mass-flow bypass door to decrease.

5. The system of claim 1, wherein PT0 is calculated based on air data, the air data comprising outside ambient temperature, altitude, and airspeed.

6. The system of claim 1, wherein the air-mass-flow bypass door is tuned in accordance with operational parameters of the engine.

7. The system of claim 1, wherein, when the air-mass-flow bypass door is open, the selected amount of air reduces spillage drag relative to a condition in which the air-mass-flow bypass door is closed.

8. (canceled)

9. A system comprising:
a forward-facing airframe-inlet duct interoperably coupled to an inlet of an engine of an aircraft;
a spring-loaded air-mass-flow bypass door coupled to the forward-facing airframe-inlet duct and operable to allow a variable amount of air entering an inlet of the forward-facing airframe-inlet duct to bypass the inlet of the engine; and
wherein the variable amount of air optimizes engine air-mass-flow intake and minimizes spillage drag.

10. (canceled)

11. The system of claim 9, wherein the spring-loaded air-mass-flow bypass door is coupled to a tuned spring that resists opening of the spring-loaded air-mass-flow bypass door.

12. The system of claim 11, wherein the spring-loaded air-mass-flow bypass door opens and closes responsive to air pressure on the spring-loaded air-mass-flow bypass door.

13. (canceled)

14. (canceled)

15. The system of claim 9, wherein the spring-loaded air-mass-flow bypass door is tuned in accordance with operational parameters of the engine.

16. The system of claim 9, wherein, when the spring-loaded air-mass-flow bypass door is open, the variable amount of air reduces spillage drag relative to a condition in which the spring-loaded air-mass-flow bypass door is closed.

17. (canceled)

18. A method comprising:
sensing an air-pressure value within a forward-facing airframe-inlet duct and adjacent to an inlet of an engine coupled to the forward-facing airframe-inlet duct;
comparing the sensed air-pressure value to a free-stream ambient air-pressure value;
responsive to the comparing, determining an optimal position of an air-mass-flow bypass door coupled to the forward-facing airframe-inlet duct
wherein the optimal position optimizes air-mass-flow intake to the engine and minimizes spillage drag; and
responsive to the determining, positioning the air-mass-flow bypass door to be in the optimal position.

19. The method of claim 18, wherein the optimal position results in a reduction of spillage drag.

20. The method of claim 18, wherein the comparing comprises calculating a ratio of the sensed air-pressure value to the free-stream ambient air-pressure value.
